(19) United States
(12) Patent Application Publication
(10) Pub. No.: US 2012/0241409 A1
(43) Pub. Date: Sep. 27, 2012

(54) PATTERN FORMATION METHOD

(76) Inventors: Katsutoshi KOBAYASHI, Tokyo (JP); Yoshihisa Kawamura, Yokohama-shi (JP); Yuriko Seino, Yokohama-shi (JP)

(21) Appl. No.: 13/412,913

(22) Filed: Mar. 6, 2012

(30) Foreign Application Priority Data
Mar. 22, 2011 (JP) 2011-062971

(51) Int. Cl. B05D 3/10; B05D 3/02

(52) U.S. Cl. 216/37; 427/282

(57) ABSTRACT

In accordance with an embodiment, a pattern formation method includes: forming, on a first substrate, a fabrication target film having first and second regions; selectively applying, onto the first region a self-assembly material of a plurality of components that are phase-separable by a thermal treatment; baking the self-assembly material to phase-separate the self-assembly material into the components; removing any one of the components to form a first pattern; applying a curable resin onto the second region of the fabrication target film; bringing a dented second substrate corresponding to an arbitrary pattern closer to and into contact with the curable resin so that the second substrate faces the curable resin; curing the curable resin; detaching the second substrate from the curable resin to form a second pattern in the curable resin; and using the first and the second patterns as masks to fabricate the fabrication target film.

### CROSS REFERENCE TO RELATED APPLICATIONS

This application is based upon and claims the benefit of priority from the prior Japanese Patent Application No. 2011-062971, filed on Mar. 22, 2011, the entire contents of which are incorporated herein by reference.

### FIELD

Embodiments described herein relate generally to a pattern formation method.

### BACKGROUND

As a technique adaptable to both pattern miniaturization and mass production in the manufacture of semiconductor devices, attention is focused on a nanoimprint method to transfer a form of an original plate to a wafer which is a transferee substrate.

However, conventional nanoimprint processes have required imprinting and pattern formation not only in a chip formation region on the wafer to serve as chips but also in an area on the peripheral edge of the wafer which does not serve as products (see the sign Rp in FIG. 5). This is attributed to concern over an etching amount difference that may be made in processes after pattern transfer such as a foundation film fabrication process and a CMP process if there is a pattern coarseness-finesse difference between the chip formation region and the peripheral edge. As a result, the number of imprinting per wafer is disadvantageously increased compared to a required amount, which leads to a lower imprint throughput and to a cost increase in the end.

### BRIEF DESCRIPTION OF THE DRAWINGS

In the accompanying drawings:

FIG. 1 is a process flow chart of a pattern formation method according to a first embodiment;

FIGS. 2A to 21 are schematic process views explaining the pattern formation method shown in FIG. 1;

FIG. 3 is a process flow chart of a pattern formation method according to a comparative example;

FIGS. 4A to 4F are schematic process views explaining the pattern formation method shown in FIG. 3;

FIG. 5 is a top view explaining the disadvantage of the comparative example;

FIG. 6 is a process flow chart of a pattern formation method according to a second embodiment;

FIGS. 7A to 7I are schematic process views explaining the pattern formation method shown in FIG. 6;

FIG. 8 is a process flow chart of a pattern formation method according to a third embodiment;

FIGS. 9A to 9K are schematic process views explaining the pattern formation method shown in FIG. 8;

FIG. 10 is a process flow chart of a pattern formation method according to a fourth embodiment; and

FIGS. 11A to 11H are schematic process views explaining the pattern formation method shown in FIG. 10.

### DETAILED DESCRIPTION

In accordance with an embodiment, a pattern formation method includes: forming, on a first substrate, a fabrication target film having a first region and a second region different from the first region; selectively applying, onto the first region of the fabrication target film, a self-assembly material constituted of a plurality of components that are phase-separable by a thermal treatment; baking the self-assembly material to phase-separate the self-assembly material into the plurality of components; removing any one of the plurality of phase-separated components to form a first pattern; applying a curable resin onto the second region of the fabrication target film; bringing a dented second substrate corresponding to an arbitrary pattern closer to and into contact with the curable resin so that the second substrate faces the curable resin; curing the curable resin; detaching the second substrate from the curable resin to form a second pattern in the curable resin; and using the first pattern and the second pattern as masks to fabricate the fabrication target film.

Embodiments will now be explained with reference to the accompanying drawings.

In the embodiments described below by way of example, a pattern is formed by optical nanoimprinting on an interlayer insulating film such as a silicon oxide film formed on a semiconductor substrate of, for example, silicon. However, the present invention is not in the least limited to the following embodiments. For example, a ceramic substrate or a glass substrate can also be used as a substrate instead of the semiconductor substrate. The fabrication target film is not limited to the insulating film either. For example, a semiconductor layer such as a silicon layer or a conductive layer such as a metal layer can also be used. Moreover, it should be understood that the present invention is not only applicable to the optical nanoimprinting but also applicable to thermal nanoimprinting. In this case, a heat-curable resin may be used as a curable resin instead of a light-curable resin, and a heat curing process may be used instead of a light curing process.

### (1) First Embodiment

(a) Schematic Process Flow

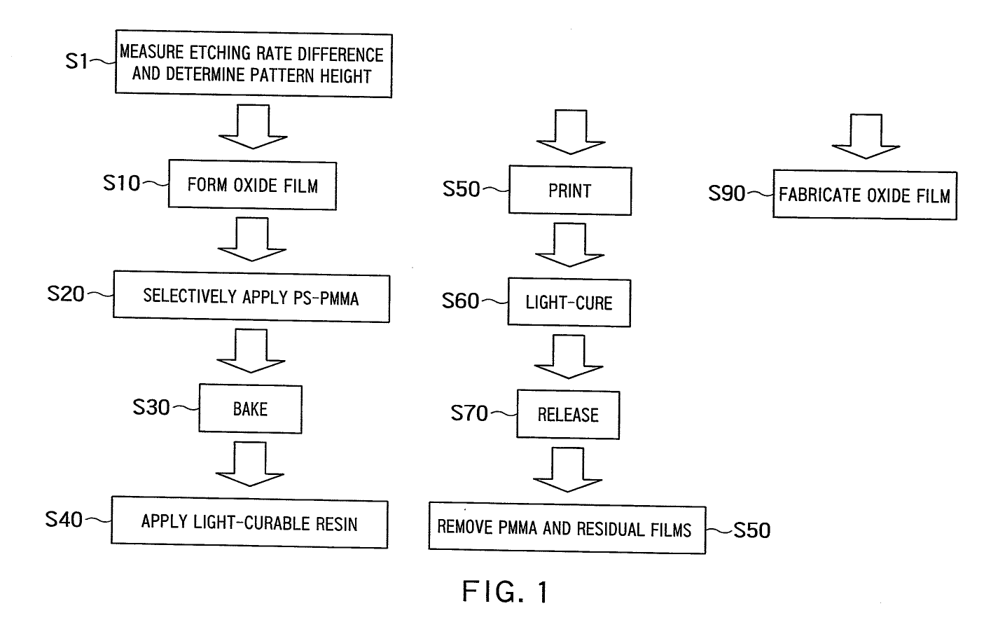

FIG. 1 is a process flow chart of a pattern formation method according to the first embodiment. First, a process according to the present embodiment is roughly described with reference to FIG. 1.

Initially, as a preprocess step, an etching rate difference between a self-assembly material for forming a pattern in a peripheral region of the semiconductor substrate and the light-curable resin is previously measured. The thickness of the pattern in the peripheral region to be formed from the self-assembly material and the height of a pattern made of the light-curable resin are determined depending on the etching rate difference (S1). As a result, the fabrication target film can be satisfactorily fabricated in a final edging step (S90) that uses the pattern in the peripheral region and the light-curable resin pattern as masks. As will be described later, in the following embodiments, the thickness of the self-assembly material is set at about 30 nm, and the height of the light-curable resin pattern is set at about 60 nm. It should, however, be understood that the above thickness and height are not limitations and that optimum thickness and height are determined in accordance with required specifications of products.

Furthermore, an oxide film is formed as a fabrication target film on the semiconductor substrate (S10).

As a self-assembly material made of a plurality of components, polystyrene-polymethyl methacrylate (hereinafter referred to as “PS-PMMA”) is then selectively applied to the peripheral region of the oxide film (S20). Instead of PS-PMMA, polystyrene-polybutadiene, polystyrene-polyisoprene, and polystyrene-poly (4-vinylpyridine), for example, can be used as self-assembly materials.

PS-PMMA is then baked for phase separation (S30), and the light-curable resin is applied to the chip formation region (40). Further, a template substrate is brought closer to and into contact with the light-curable resin to transfer a pattern on the template substrate to the light-curable resin (S50).

UV light is then applied to the light-curable resin through the template substrate to cure the light-curable resin (S60).

Furthermore, the template substrate is detached from the light-curable resin (S70).

One of the components of the phase-separated PS-PMMA is then selectively removed, and at the same time, inter-pattern residuals in a dented pattern made of the light-curable resin are removed (S80).

Finally, the oxide film is selectively removed by using the pattern made of the residual PS-PMMA components and the light-curable resin dented pattern as masks such that the oxide film is fabricated (S90).

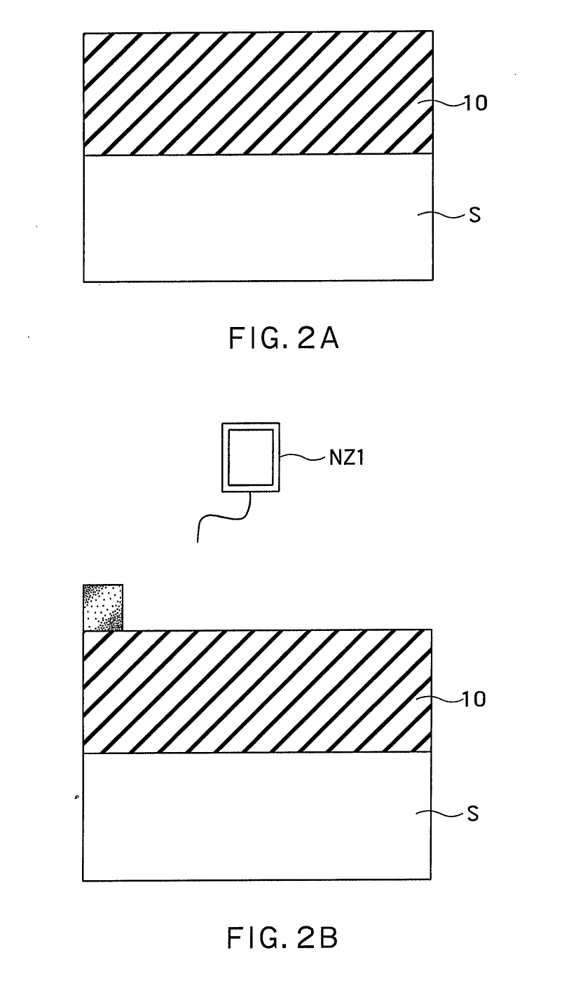

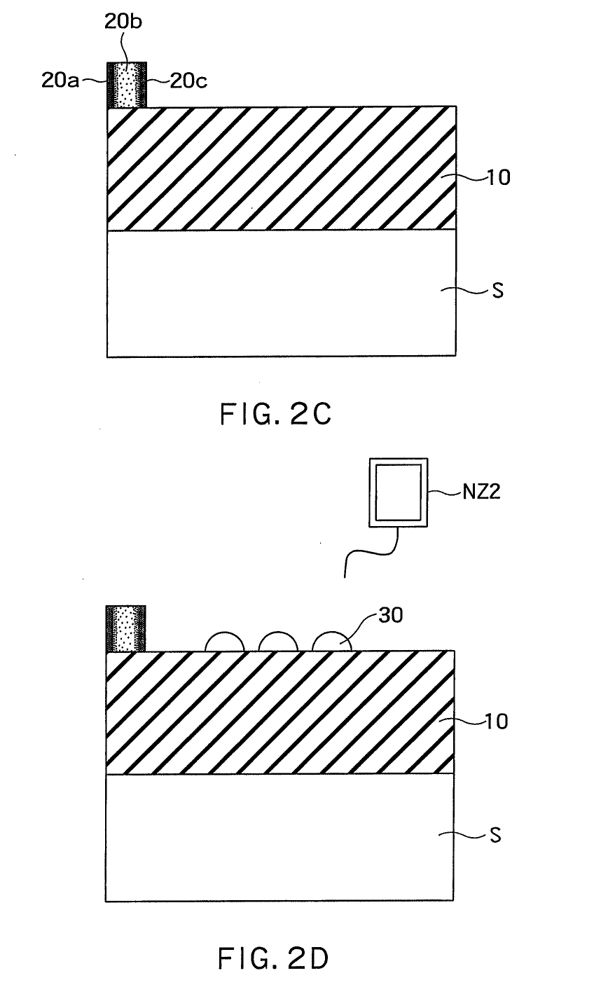

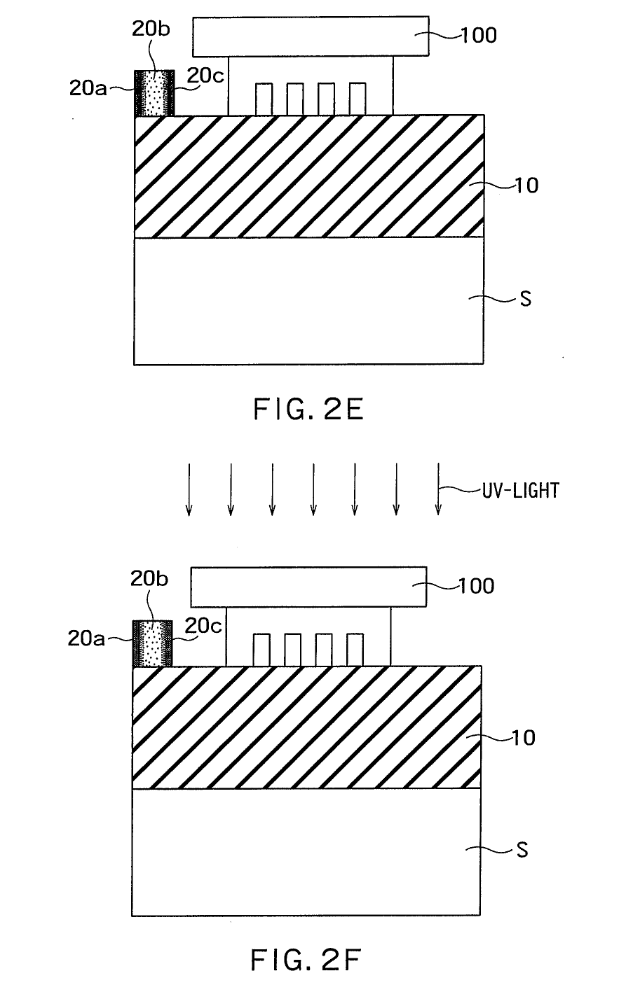

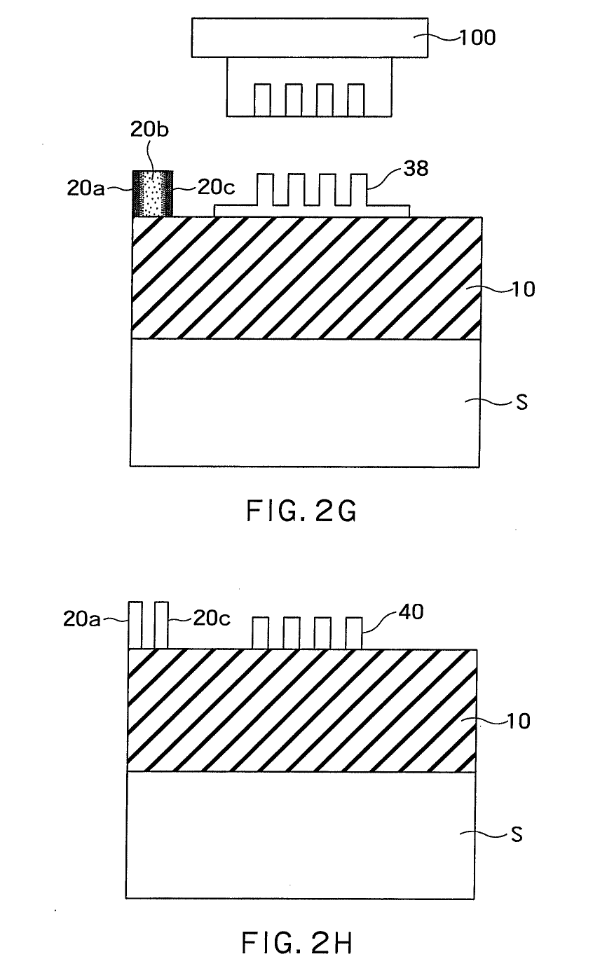

The flow in FIG. 1 is described in more detail with reference to schematic process views of FIG. 2A to FIG. 2I.

(b) Formation of Fabrication Target Film (S10)

In the present embodiment, an oxide film 10 having a thickness of about 200 nm is formed on a semiconductor substrate S, as shown in FIG. 2A. In the present embodiment, the semiconductor substrate S and the oxide film 10 correspond to, for example, a first substrate and a fabrication target film, respectively.

(c) Selective Application of PS-PMMA (S20)

As shown in FIG. 2B, PS-PMMA is applied to the peripheral region of the oxide film 10 by roller coating, scan coating, or spray coating to reach a thickness of about 30 nm, thereby forming a PS-PMMA layer 20. In the example shown in FIG. 2B, spray is applied from a nozzle NZ1. In the present embodiment, the peripheral region corresponds to, for example, a first region.

(d) Baking (S30)

In the present embodiment, the PS-PMMA layer 20 is baked at 200° C. As a result, the PS-PMMA layer 20 is phase-separated into patterns 20a and 20c which is made of one of polystyrene and polymethyl methacrylate, for example, polystyrene, and a pattern 20b which is made of the other of polystyrene and polymethyl methacrylate, for example, polymethyl methacrylate. In the present embodiment, polystyrene and polymethyl methacrylate correspond to, for example, a plurality of components that constitute the self-assembly material.

(e) Application of Light-Curable Resin (S40)

As shown in FIG. 2D, a light-curable resin 30 is selectively applied to the chip formation region on the oxide film 10 from a nozzle NZ2, for example, by an inkjet method. In the present embodiment, the chip formation region corresponds to, for example, a second region.

(f) Printing (S50)

As shown in FIG. 2E, a template substrate 100 having a dented pattern adapted to a desired pattern is brought closer to and into contact with the light-curable resin 30 so that the light-curable resin fills valley patterns within the dented pattern. Consequently, the pattern of the template substrate 100 is transferred to the light-curable resin 30. In the present embodiment, the template substrate 100 corresponds to, for example, a second substrate.

(g) Light Curing (S60)

As shown in FIG. 2F, UV light is applied to the light-curable resin 30 through the template substrate 100 to cure the light-curable resin 30.

(h) Release

As shown in FIG. 2G, the template substrate 100 is detached from the cured light-curable resin 30 so that a dented pattern 38 having a height of about 60 nm is formed.

(i) Removal of PMMA and Residual Films

Inter-pattern residuals in the dented pattern 38 and the polymethyl methacrylate pattern 20b are removed by reactive ion etching (RIE) at the same time. Thus, the polystyrene patterns 20a and 20c are formed in the peripheral region, and light-curable resin patterns 40 are formed in the chip formation region, as shown in FIG. 2H.

As is also apparent from FIG. 2H, the kind of self-assembly material needs to be determined depending on the line distance of the patterns 40 so that the width of the pattern 20b, that is, the distance between the patterns 20a and 20c substantially corresponds to distance between the patterns 40 formed in the chip formation region. In the present embodiment, the patterns 20a and 20c correspond to, for example, a first pattern, and the patterns 40 correspond to, for example, a second pattern.

(j) Fabrication of Oxide Film

Finally, the polystyrene patterns 20a and 20c and the light-curable resin patterns 40 are used as masks to fabricate the oxide film 10 by RIE with a fluorine-based gas. Thus, a pattern 50 corresponding to the dented pattern of the template substrate 100 is obtained, as shown in FIG. 2I.

### (2) Comparative Example

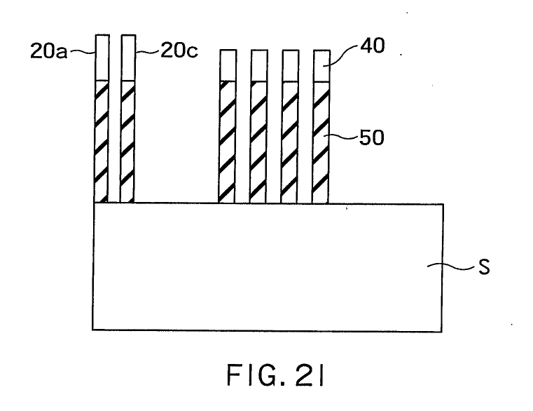

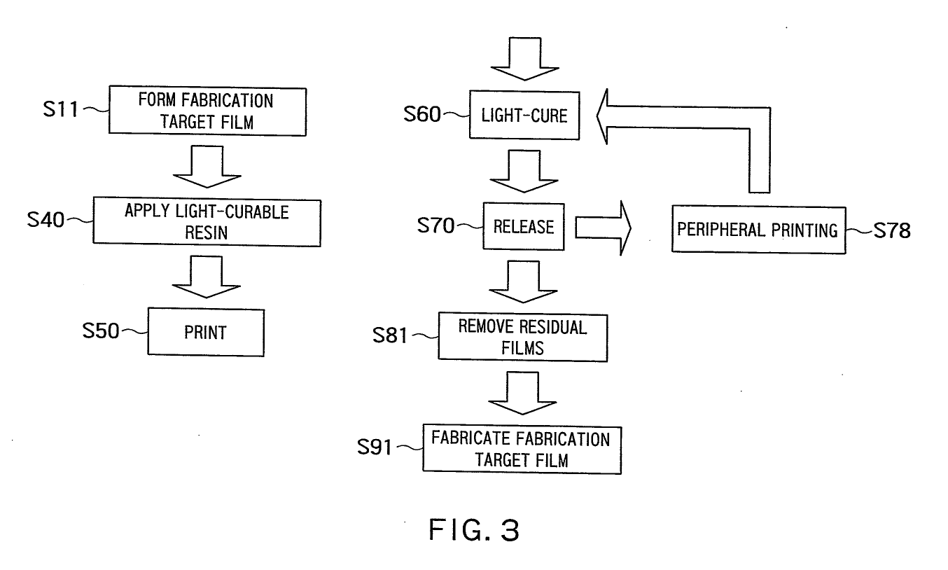

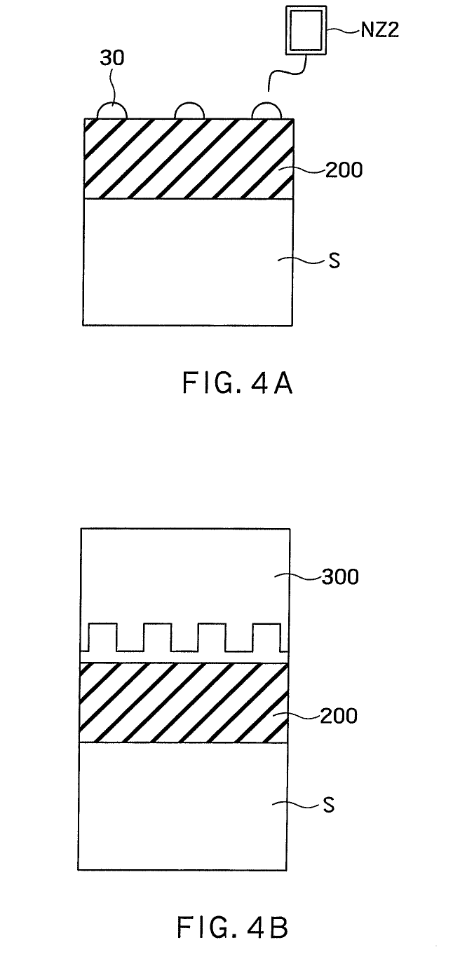

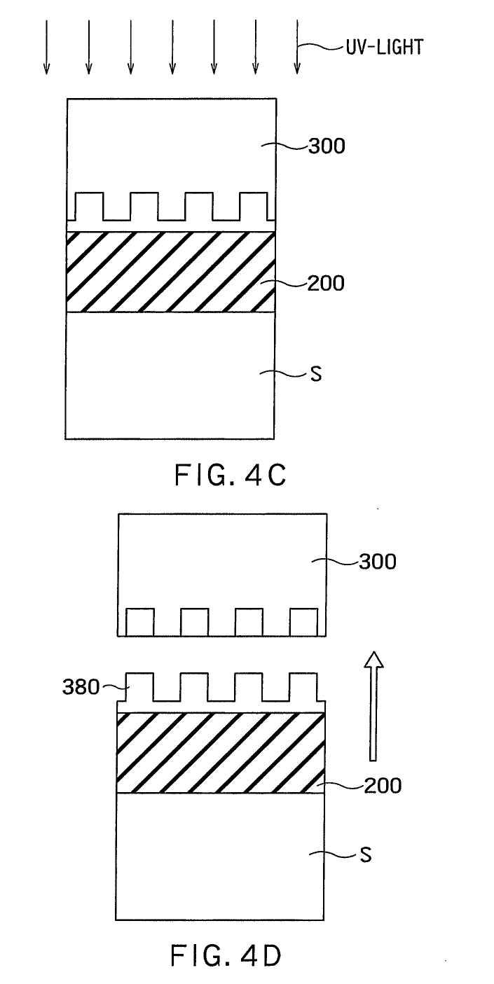

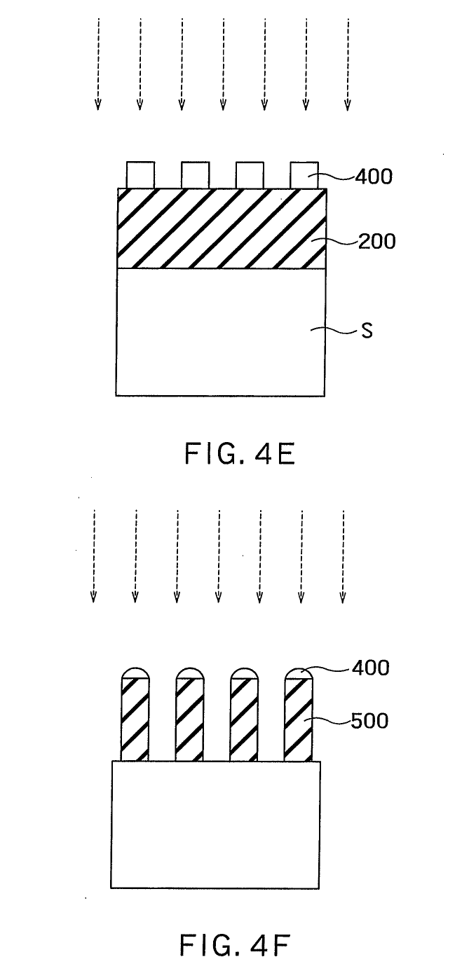

FIG. 3 is a flow chart of a pattern formation method according to a comparative example. As shown in its process S51, printing is also performed in a peripheral region. Steps according to this comparative example are described with reference to FIG. 4A to FIG. 4F.

First, a fabrication target film 200 is formed on a semiconductor substrate S (FIG. 3, S11), and then droplets of a light-curable resin 30 are laid in desired positions on the fabrication target film 200 by an inkjet method as shown in FIG. 4A (FIG. 3, S40). At the same time, droplets are also laid in the peripheral region of the fabrication target film 200.

A quartz template 300 in which a desired dented pattern is formed is then brought closer to the fabrication target film 200 into contact with the light-curable resin 30 in a pattern formation region. As shown in FIG. 4B, valley patterns within the dented pattern are filled with the light-curable resin 30 (FIG. 3, S50).

As shown in FIG. 4C, UV light is then applied to cure the light-curable resin. Further, as shown in FIG. 4D, the template 300 is released from the fabrication target film 200, thereby forming a pattern 380.

A series of printing, light curing, and releasing steps described above is then also carried out for the light-curable resin 30 in the peripheral region (FIG. 3, S78).

Furthermore, anisotropic etching mainly based on oxygen plasma is used to remove residual films, and a light-curable resin pattern 400 is obtained as shown in FIG. 4E.

Finally, as shown in FIG. 4F, the formed pattern 400 is used as a mask to fabricate the fabrication target film 200 by RIE, thereby forming a pattern 500.

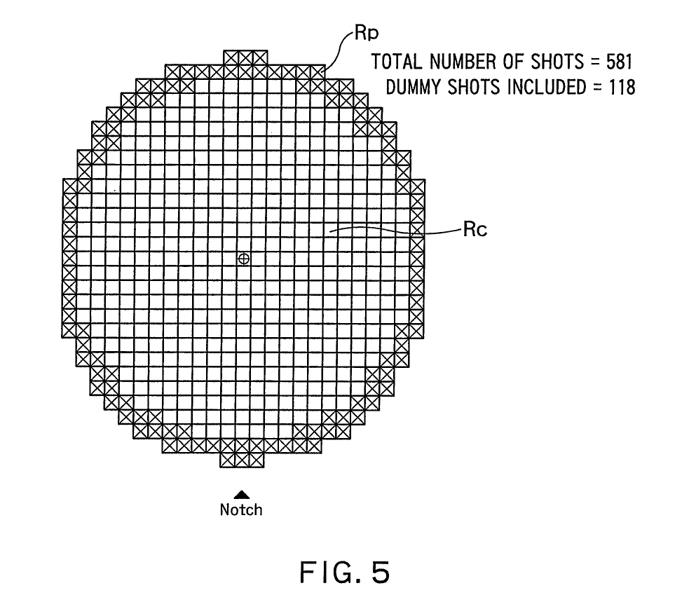

As described above, in accordance with the optical imprint process of the comparative example, there is concern over an etching amount difference that may result from a coarseness-finesse difference between the chip formation region having patterns and the peripheral region in processes after, for example, fabrication and CMP. Therefore, as shown in FIG. 5, not only a chip formation region Rc but also a peripheral region Rp needs imprinting to form patterns therein. Accordingly, the number of imprinting per wafer is more than necessary. For example, in the example shown in FIG. 5, 118 dummy shots in the peripheral region Rp account for about 20% of a total of 581 shots in the chip formation region Rc and the peripheral region Rp. This leads to a lower imprint throughput and thus to a cost increase.

In contrast, in accordance with the first embodiment described above, the peripheral region can be patterned without using an expensive lithography unit. Consequently, an etching amount difference is not made by a coarseness-finesse difference between the chip formation region having patterns and the peripheral region having no patterns in processes after, for example, fabrication and CMP, and the number of imprinting can be reduced. This allows an improved nanoimprint throughput and reduced manufacturing costs.

### (3) Second Embodiment

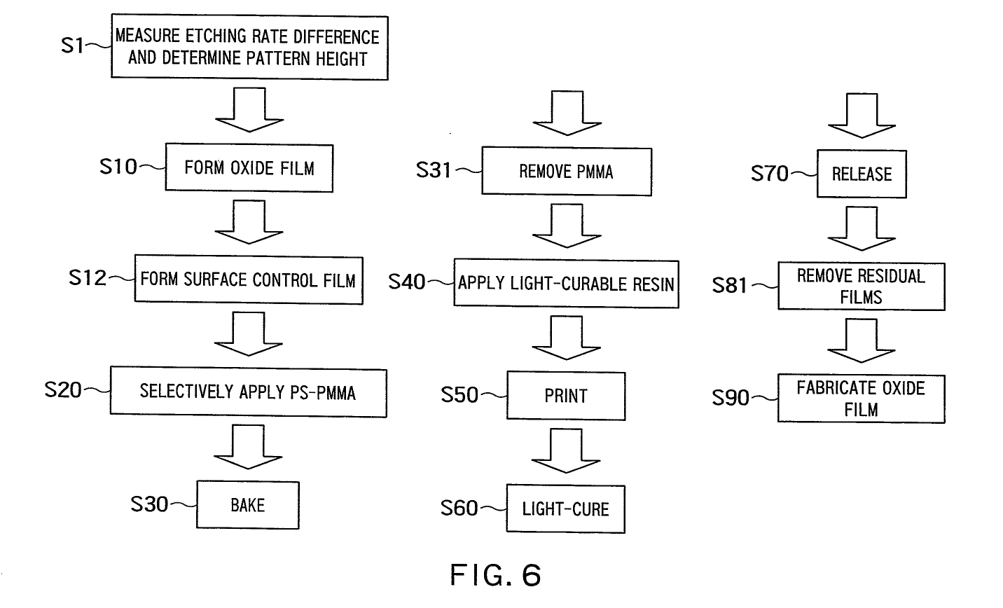

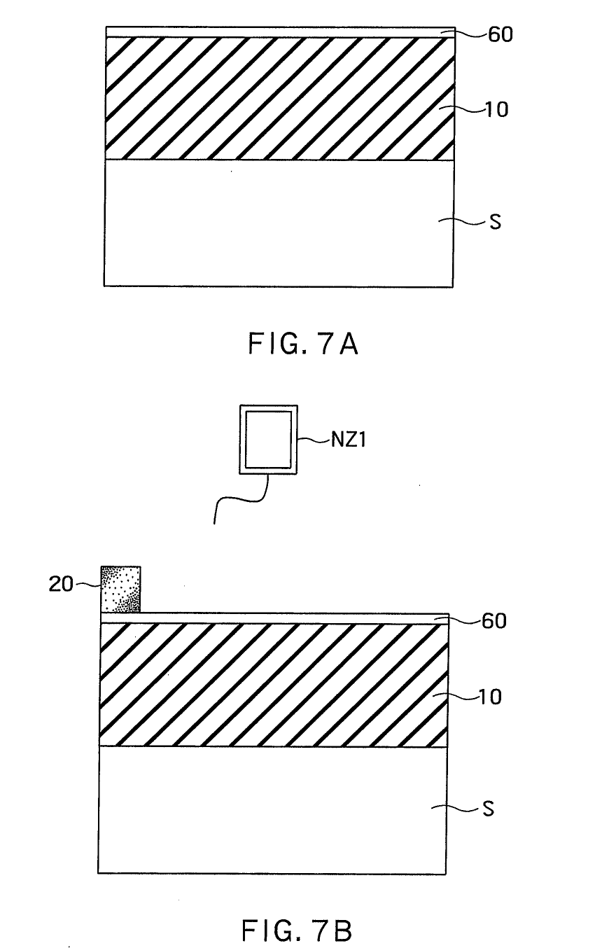

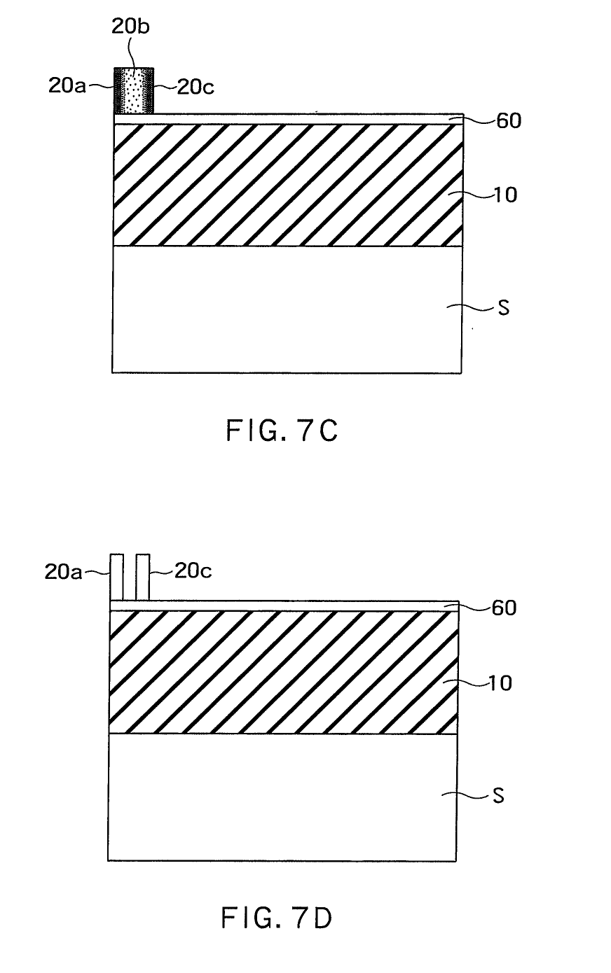

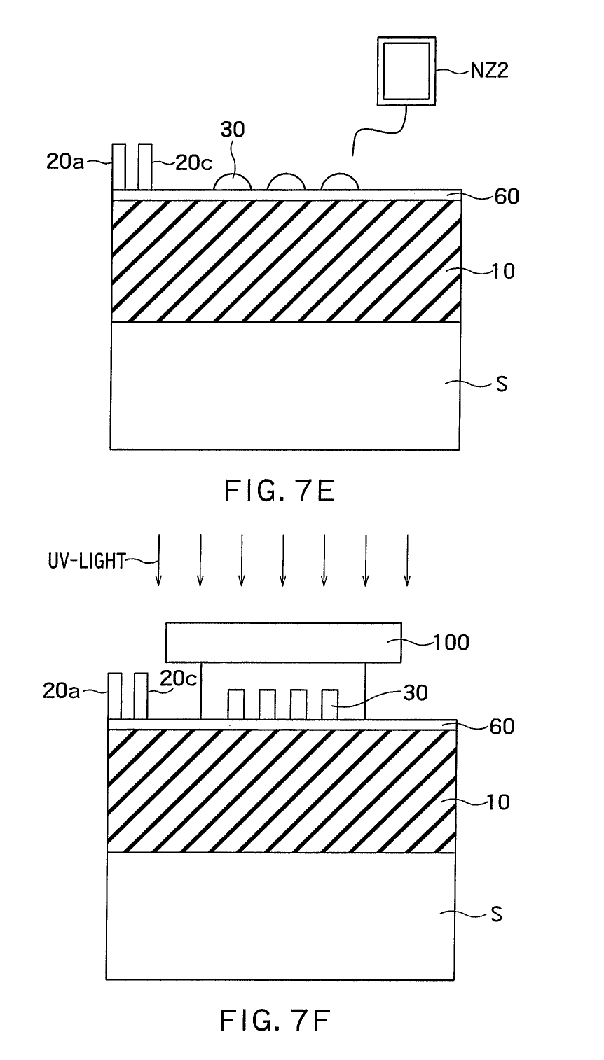

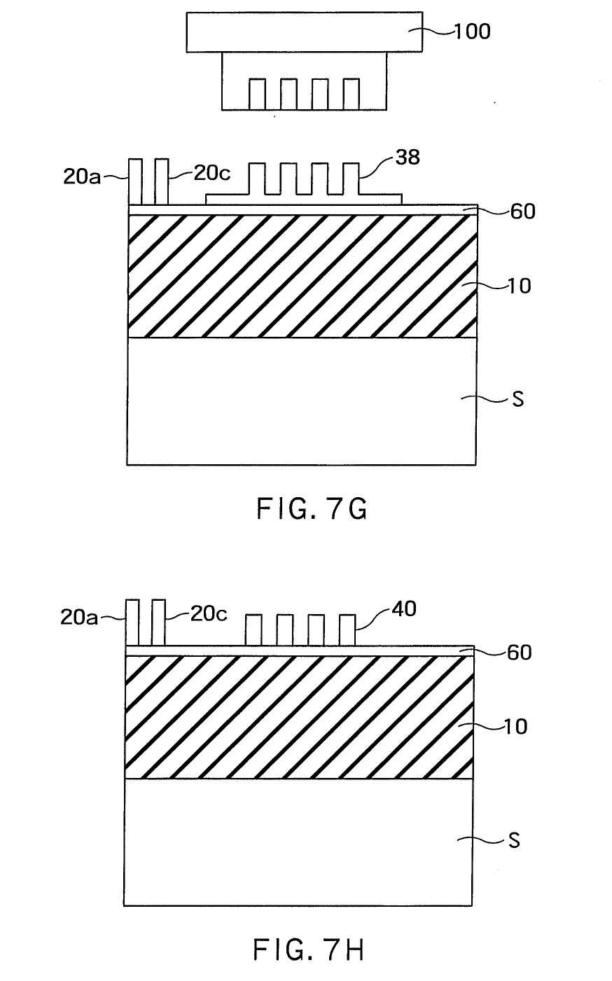

FIG. 6 is a flow chart of a pattern formation method according to the second embodiment. As shown in process S12 in FIG. 6, the present embodiment is characterized in that a surface control film is formed before PS-PMMA is selectively applied (S20). Specific steps according to the present embodiment are described below in order with reference to FIG. 7A to FIG. 7J.

First, as a preprocess step, an etching rate difference between a self-assembly material and a light-curable resin is previously measured. The thickness of a pattern in a peripheral region to be formed from the self-assembly material and the height of a pattern made of the light-curable resin are determined depending on the etching rate difference (S1).

An oxide film 10 is formed on a semiconductor substrate S (FIG. 6, S10), and then a surface control film 60 is formed on the oxide film 10 as shown in FIG. 7A (FIG. 6, S12). The surface control film 60 has both the property of controlling the surface contact angle of the self-assembly material and the property of closely contacting a foundation layer (the oxide film 10) of the light-curable resin. This property of controlling the surface contact angle allows the angle of contact with the foundation layer of the self-assembly material to be controlled at a desired value. The contact angle controlled according to the present embodiment is 80 degrees as in the case of water. In the present embodiment, the surface control film 60 corresponds to, for example, a first film doubling as a second film.

As shown in FIG. 7B, PS-PMMA is then selectively applied to the peripheral region of the surface control film 60 by roller coating, scan coating, or spray coating to reach a thickness of 30 nm, thereby forming a PS-PMMA layer 20 (FIG. 6, S20). The PS-PMMA layer 20 is then baked at 200° C. As a result, the PS-PMMA layer 20 is phase-separated into patterns 20a and 20c made of polystyrene, and a pattern 20b made of polymethyl methacrylate, as shown in FIG. 7C (FIG. 6, S30).

As shown in FIG. 7D, the polymethyl methacrylate pattern 20b is then removed by RIE using an oxygen gas (FIG. 6, S31).

As shown in FIG. 7E, a light-curable resin 30 is then selectively applied to a chip formation region on the oxide film 10 from a nozzle NZ2 by the inkjet method (FIG. 6, S40).

A template substrate 100 is then brought closer to and into contact with the light-curable resin 30 to transfer a dented pattern of the template substrate 100 to the light-curable resin 30 (FIG. 6, S50). Further, as shown in FIG. 7, UV light is applied to the light-curable resin 30 through the template substrate 100 to cure the light-curable resin 30 (FIG. 6, S60).

As shown in FIG. 7G, the template substrate 100 is then detached from the cured light-curable resin 30, and a dented pattern 38 having a height of about 60 nm is formed (FIG. 6, S70).

Inter-pattern residual films in the dented pattern 38 are then removed by RIE using a fluorine gas, and light-curable resin patterns 40 are formed, as shown in FIG. 7H (FIG. 6, S81).

Finally, the polystyrene patterns 20a and 20c and the light-curable resin patterns 40 are used as masks to fabricate the oxide film 10 by RIE with a fluorine-based gas, and a pattern 50 corresponding to the dented pattern of the template substrate 100 is obtained, as shown in FIG. 7I (FIG. 6, S90).

In accordance with the present embodiment, the control film 60 having both the property of controlling the surface contact angle of the self-assembly material and the property of closely contacting the light-curable resin is formed before PS-PMMA is selectively applied. Consequently, the PS-PMMA layer 20 is more satisfactorily phase-separated, and the template substrate 100 is also more easily detached.

This allows an improved nanoimprint yield.

### (4) Third Embodiment

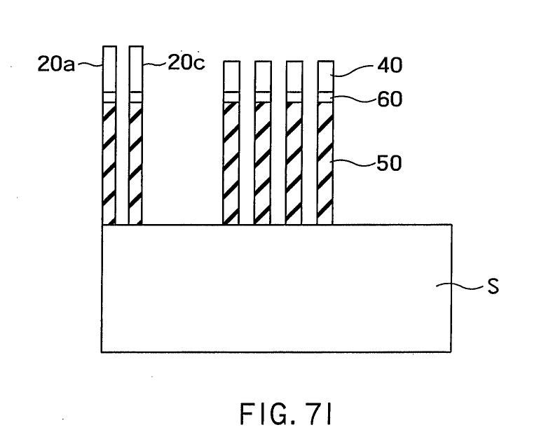

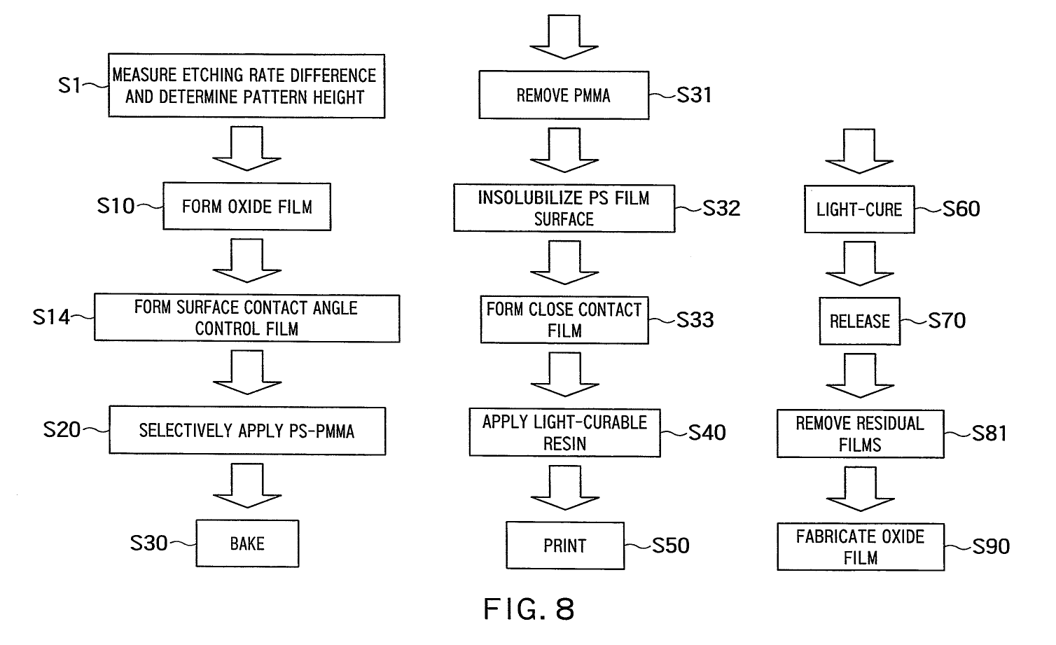

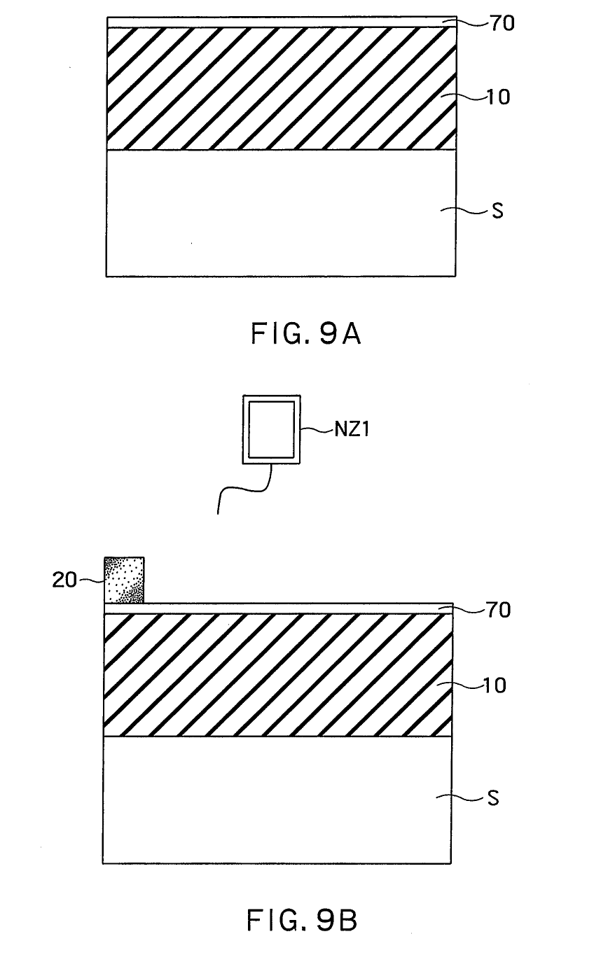

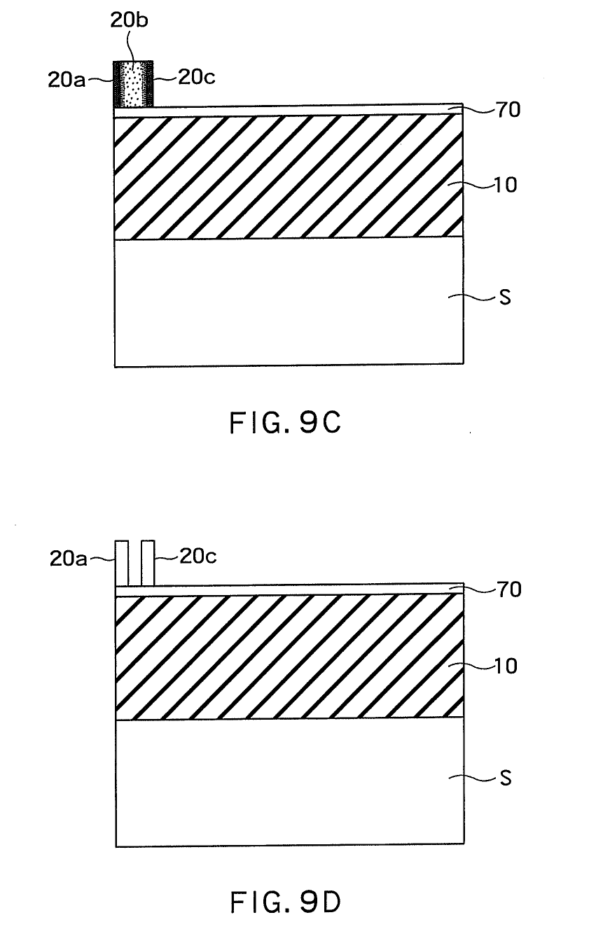

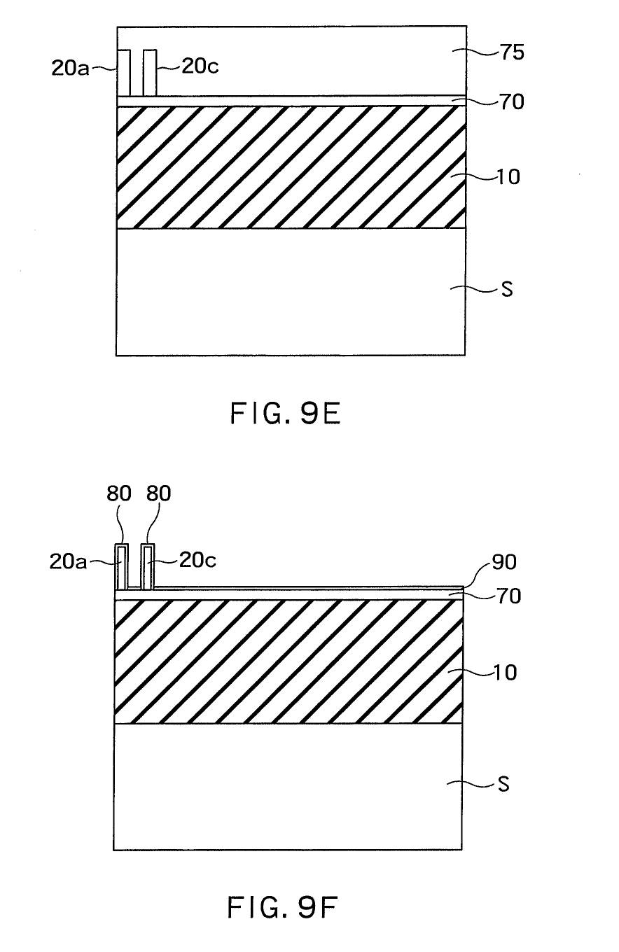

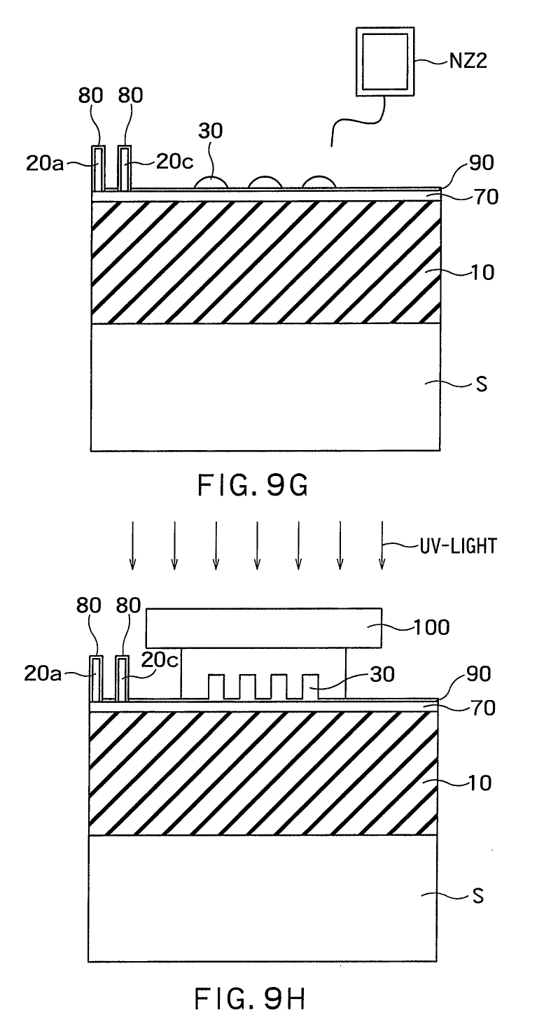

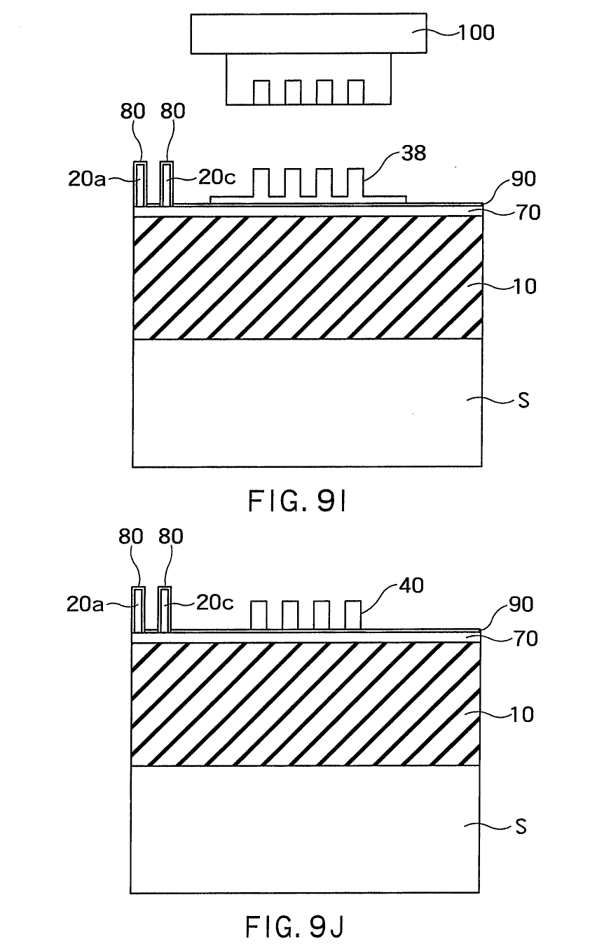

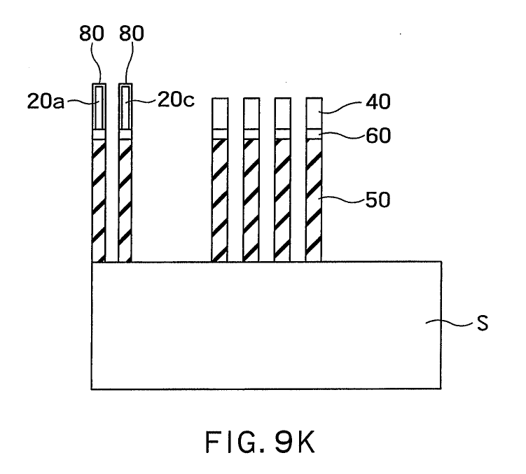

FIG. 8 is a flow chart of a pattern formation method according to the third embodiment. As shown in processes S14 and S33 in FIG. 8, the present embodiment is firstly characterized in that a surface contact angle control film is formed before PS-PMMA is selectively applied (S20) and in that a close contact film is formed before a light-curable resin is applied (S40). Moreover, as shown in process S32 in FIG. 8, the present embodiment is secondly characterized in that the surface of a PS film is insolubilized before the close contact film is formed (S33). Specific steps according to the present embodiment are described below in order with reference to FIG. 9A to FIG. 9J.

First, as in the first and second embodiments described above, as a preprocess step, an etching rate difference between a self-assembly material and a light-curable resin is previously measured. The thickness of a pattern in a peripheral region to be formed from the self-assembly material and the height of a pattern made of the light-curable resin are determined depending on the etching rate difference (S1).

An oxide film 10 having a thickness of about 200 nm is formed on a semiconductor substrate S, and then a surface contact angle control film 70 which sets the angle of contact with a PS-PMMA film to 80 degrees is formed on the oxide film 10, as shown in FIG. 9A (S14). In the present embodiment, the surface contact angle control film 70 corresponds to, for example, a first film.

As shown in FIG. 9B, PS-PMMA is then selectively applied to the peripheral region of the surface contact angle control film 70 by roller coating, scan coating, or spray coating to reach a thickness of 30 nm, thereby forming a PS-PMMA layer 20 (FIG. 8, S20).

The PS-PMMA layer 20 is then baked at 200□C. As a result, the PS-PMMA layer 20 is phase-separated into patterns 20a and 20c made of polystyrene, and a pattern 20b made of polymethyl methacrylate, as shown in FIG. 9C (FIG. 8, S30).

As shown in FIG. 9D, the polymethyl methacrylate pattern 20b is then removed by RIE using an oxygen gas (FIG. 8, S31).

As shown in FIG. 9E, a melamine resin precursor is used as a resist insolubilizer material, and a melamine resin precursor film 75 is formed to reach a thickness that totally covers the polystyrene patterns 20a and 20c. The resin precursor film 75 is baked at about 150° C. to form a melamine resin film 80 having a thickness of about 3 nm on the surfaces of the patterns 20a and 20c (FIG. 8, S32).

As shown in FIG. 9F, a close contact film 90 is formed to reach a thickness of about 3 nm (FIG. 8, S32) The close contact film 90 is an organic film used to improve the property of closely contacting a light-curable resin to be formed in a subsequent process. At this point, the melamine resin film 80 has been formed on the surfaces of the patterns 20a and 20c. Thus, any selected combination of a close contact film and a self-assembly material may not cause the patterns 20a and 20c to melt in the step of forming the close contact film 90. In the present embodiment, the close contact film 90 corresponds to, for example, a second film.

Furthermore, as in the embodiments described above, a light-curable resin 30 is selectively dropped in the chip formation region of the close contact film 90 by the inkjet method (FIG. 8, S40, and FIG. 9G). A template substrate 100 is brought into contact with the light-curable resin 30 (FIG. 8, S50). As shown in FIG. 9H, UV light is then applied to cure the light-curable resin 30 (FIG. 8, S60). Further, the template substrate 100 is detached from the close contact film 90 (FIG. 8, S70), a dented pattern 38 having a height of about 60 nm is formed, as shown in FIG. 9I. Inter-pattern residuals in the dented pattern 38 are then removed by RIE using a fluorine-based gas, and patterns 40 are formed (FIG. 8, S81, FIG. 9I). Finally, the polystyrene patterns 20a and 20c and the light-curable resin patterns 40 are used as masks to selectively remove the close contact film 90, the surface angle control film 70, and the oxide film 10 by RIE using a fluorine-based gas (FIG. 8, S90), and a pattern 50 is formed, as shown in FIG. 9J.

In this way, in accordance with the present embodiment as well, the PS-PMMA layer 20 is satisfactorily phase-separated, and at the same time, the template substrate 100 is easily detached.

### (5) Fourth Embodiment

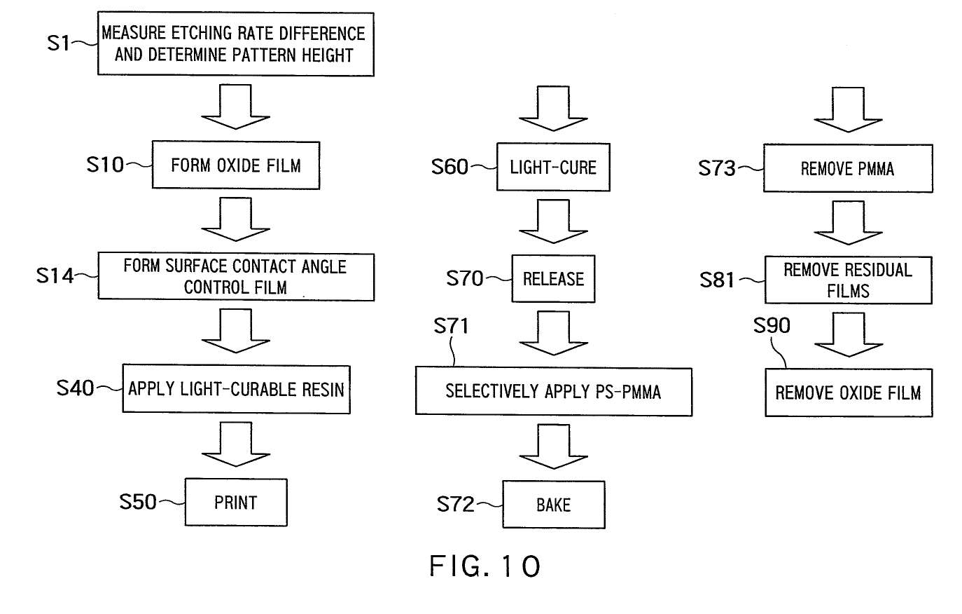

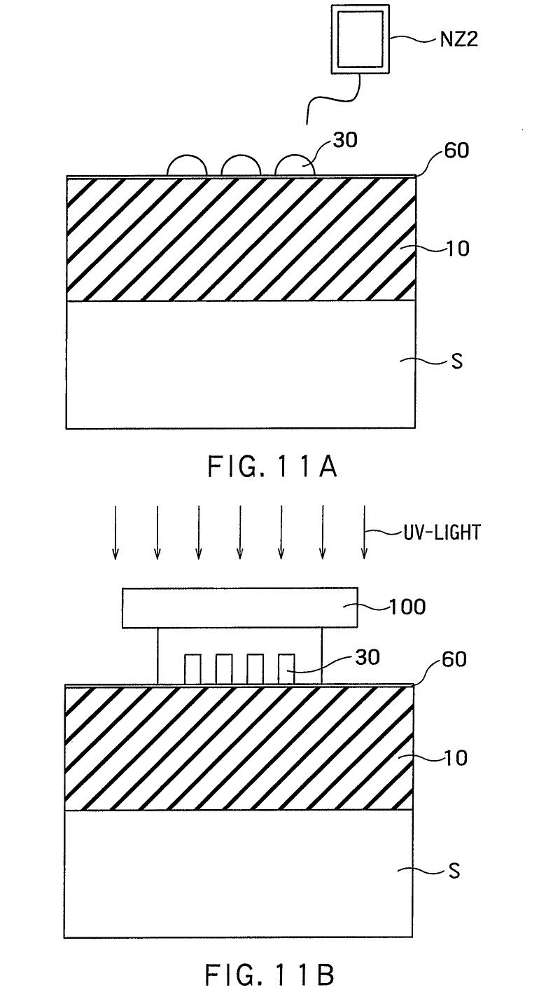

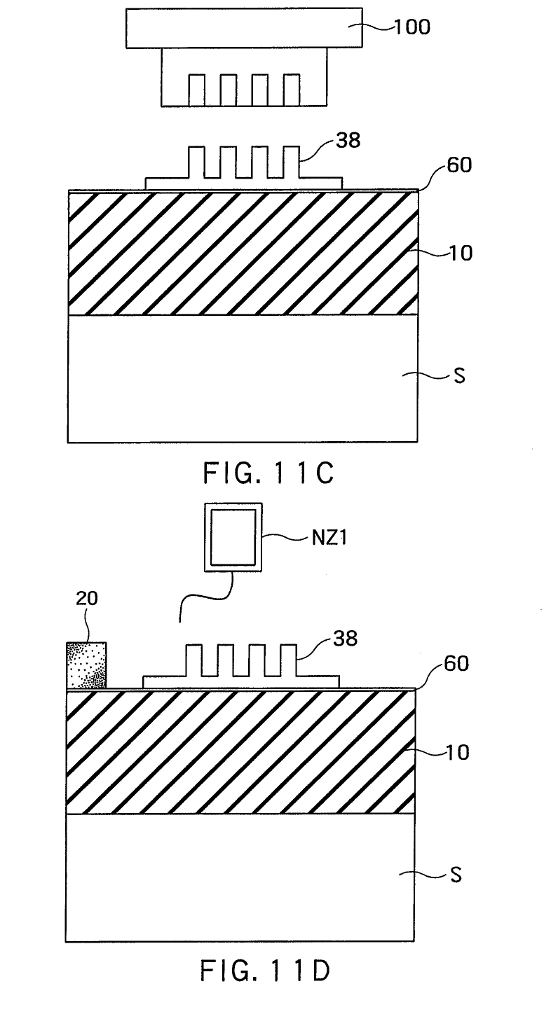

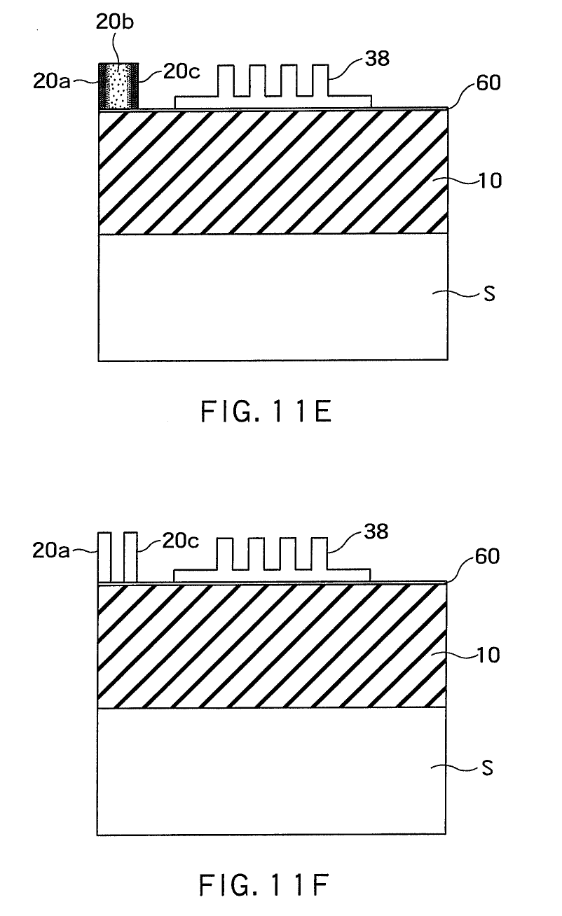

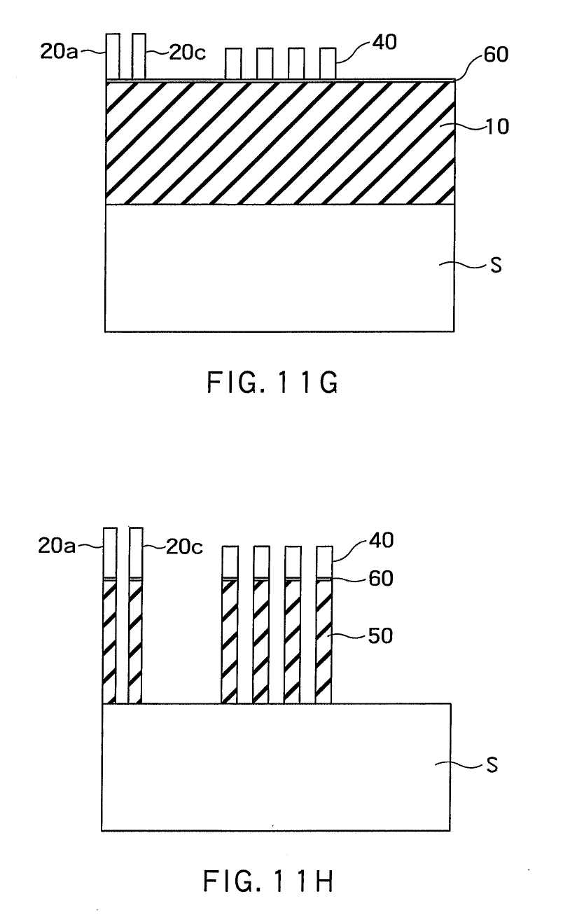

FIG. 10 is a flow chart of a pattern formation method according to the fourth embodiment. The present embodiment is characterized in that a pattern in a peripheral region is formed (S71 to S73) after a pattern in a chip formation region is formed (S32 to S70). Specific steps according to the present embodiment are described below in order with reference to FIG. 11A to FIG. 11H.

First, as in the second embodiment described above, as a preprocess step, an etching rate difference between a self-assembly material and a light-curable resin is previously measured. The thickness of a pattern in a peripheral region to be formed from the self-assembly material and the height of a pattern made of the light-curable resin are determined depending on the etching rate difference (S1).

An oxide film 10 having a thickness of about 200 nm is then formed on a semiconductor substrate S (FIG. 10, S10). Subsequently, a surface control film 60 having both the property of controlling the surface contact angle of the self-assembly material to reach a contact angle of 80 degrees and the property of closely contacting a foundation layer (the oxide film 10) of the light-curable resin is formed (FIG. 10, S14).

As shown in FIG. 11A, a light-curable resin 30 is then selectively applied to the chip formation region on the oxide film 10 from a nozzle NZ2 by the inkjet method (FIG. 10, S40).

A template substrate 100 is then brought closer to and into contact with the light-curable resin 30 to transfer a dented pattern of the template substrate 100 to the light-curable resin 30 (FIG. 10, S50). Further, as shown in FIG. 11B, UV light is applied to the light-curable resin 30 through the template substrate 100 to cure the light-curable resin 30 (FIG. 10, S60).

As shown in FIG. 11C, the template substrate 100 is then detached from the cured light-curable resin 30, and a dented pattern 38 having a height of about 60 nm is formed (FIG. 10, S70).

As shown in FIG. 11D, PS-PMMA is then selectively applied to the peripheral region of the surface control film 60 by roller coating, scan coating, or spray coating to reach a thickness of 30 nm, thereby forming a PS-PMMA layer 20 (FIG. 10, S71).

The PS-PMMA layer 20 is then baked at 200° C. As a result, the PS-PMMA layer 20 is phase-separated into patterns 20a and 20c made of polystyrene, and a pattern 20b made of polymethyl methacrylate, as shown in FIG. 11E (FIG. 10, S72).

As shown in FIG. 11F, the polymethyl methacrylate pattern 20b is then removed by RIE using an oxygen gas (FIG. 10, S73).

Inter-pattern residual films in the dented pattern 38 are then removed by RIE using a fluorine gas, and light-curable resin patterns 40 are formed, as shown in FIG. 11G (FIG. 10, S81).

Finally, the polystyrene patterns 20a and 20c and the light-curable resin patterns 40 are used as masks to fabricate the oxide film 10 by RIE using a fluorine-based gas, and a pattern 50 corresponding to the dented pattern of the template substrate 100 is obtained, as shown in FIG. 11H (FIG. 10, S90).

As described above, the pattern in the peripheral region is formed after the pattern in the chip formation region is formed. This also allows an improved nanoimprint throughput and reduced manufacturing costs.

While several embodiments have been described above, the present invention is not limited to the embodiments described above, and various modifications can be made. For example, depending on the kind of fabrication target film, a film having the property of controlling the surface contact angle of the self-assembly material alone may be formed in the peripheral region without particularly using the close contact film if the property of closely contacting the light-curable resin is high. Moreover, in the embodiments described above, the PS-PMMA film is formed in the peripheral region, and the light-curable resin pattern is formed in the chip formation region. However, the present invention is not limited thereto. The PS-PMMA film and the light-curable resin pattern may be formed in any regions within the same layer on the fabrication target film.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A pattern formation method comprising:
forming, on a first substrate, a fabrication target film having a first region and a second region different from the first region;
selectively applying, onto the first region of the fabrication target film, a self-assembly material constituted of a plurality of components that are phase-separable by a thermal treatment;
baking the self-assembly material to phase-separate the self-assembly material into the plurality of components;
removing any one of the plurality of phase-separated components to form a first pattern;
applying a curable resin onto the second region of the fabrication target film;
bringing a dented second substrate corresponding to an arbitrary pattern closer to and into contact with the curable resin so that the second substrate faces the curable resin;
curing the curable resin;
detaching the second substrate from the curable resin to form a second pattern in the curable resin; and
using the first pattern and the second pattern as masks to fabricate the fabrication target film.

2. The method of claim 1, further comprising
previously measuring an etching rate difference between the self-assembly material and the light-curable resin before the application of the self-assembly material and the light-curable resin,
wherein the thickness of a film of the self-assembly material and the height of a pattern made of the light-curable resin are determined depending on the measured etching rate difference.

3. The method of claim 2,
wherein the first and second patterns are line-and-space patterns, and
the line distance of the first pattern is determined depending on the line distance of the second pattern.

4. The method of claim 1,
wherein the first pattern is formed after the formation of the second pattern.

5. The method of claim 4,
wherein inter-pattern residuals in the second pattern are removed together with any one of the plurality of phase-separated components.

6. The method of claim 1, further comprising
forming a first film before the application of the self-assembly material, the first film providing the self-assembly material with an arbitrary angle of contact with a foundation layer of the self-assembly material.

7. The method of claim 6,
wherein the first film doubles as a second film having a property of closely contacting the curable resin.

8. The method of claim 6, further comprising
forming a second film having a property of closely contacting the curable resin, before the application of the curable resin.

9. The method of claim 8, further comprising
subjecting the first pattern to a resist insolubilizing treatment before the formation of the second film.

10. The method of claim 9,
wherein a melamine resin precursor is used for the resist insolubilizing treatment.

11. The method of claim 6,
wherein the angle of contact is 80 degrees.

12. The method of claim 1, further comprising
forming a second film having a property of closely contacting the curable resin, before the application of the curable resin.

13. The method of claim 12, further comprising
subjecting the first pattern to a resist insolubilizing treatment before the formation of the second film.

14. The method of claim 1,
wherein the formation of the second pattern precedes the application of the self-assembly material, the phase separation of the self-assembly material into the plurality of components, and the removal of any one of the plurality of phase-separated components.

15. The method of claim 1,
wherein the self-assembly material comprises polystyrene-polymethyl methacrylate.

16. The method of claim 1,
wherein the self-assembly material comprises polystyrene-polybutadiene.

17. The method of claim 1,
wherein the self-assembly material comprises polystyrene-polyisoprene.

18. The method of claim 1,
wherein the self-assembly material comprises polystyrene-poly (4-vinylpyridine).

19. The method of claim 1,
wherein the first region is a peripheral region of the fabrication target film.
